(19) United States
(12) Patent Application Publication
(10) Pub. No.: US 2012/0013936 A1
(43) Pub. Date: Jan. 19, 2012

(54) DEVICE MANAGEMENT SYSTEM, DEVICE MANAGEMENT APPARATUS, AND DEVICE MANAGEMENT METHOD

(76) Inventor: Masaichi SAWADA, Tokyo (JP)

(21) Appl. No.: 13/177,014

(22) Filed: Jul. 6, 2011

(30) Foreign Application Priority Data
Jul. 16, 2010 (JP) 2010-161884

(51) Int. Cl. G06K 15/02

(52) U.S. Cl. 358/1.14

(57) ABSTRACT

A device management apparatus is connected to an image forming apparatus via a first network. The device management apparatus includes a sending unit that sends identification information of the device management apparatus; a monitor unit that periodically acquires status information from the image forming apparatus in response to a request to execute a first process sent by the image forming apparatus that has received the identification information, and records the status information in a storing unit; a diagnosing unit that diagnoses fault prediction of the image forming apparatus based on the status information in response to a request to execute a second process sent by the image forming apparatus from which the status information is acquired; and a transferring unit that transfers, to a remote monitor device via a second network, report information including diagnosis results obtained by the diagnosing unit.

### BACKGROUND OF THE INVENTION

1. Field of the Invention

The present invention relates to a device management system, a device management apparatus, and a device management method, and more particularly to device management system, a device management apparatus, and a device management method for managing an image forming apparatus via a network.

2. Description of the Related Art

In image forming apparatuses (hereinafter, simply referred to as “device”) such as printers, copiers, fax machines, and multifunction peripherals, it is difficult to completely eliminate failures such as paper jams. Therefore, devices are designed in various ways to enable users to solve problems that occur due to failures by themselves.

However, there are cases where a failure can only be recovered by a maintenance person (service person). Furthermore, various professional operations may be needed for preventing failures from occurring and for stabilizing the operations of the device. For example, the device includes elements such as rollers for conveying sheets during image forming operations. Among these elements, there are consumables that gradually become worn away due to usage over a long period of time. In order to guarantee stable operation of the device, a maintenance person needs to periodically replace such consumable elements at appropriate timings (e.g., depending on the number of used sheets).

Accordingly, a contract (maintenance contract) is made between the device manufacturer or the device vendor, and the user. The user who has signed the contract receives various services from a maintenance person. Services include maintenance operations such as periodically cleaning the device and replacing consumable elements, and quickly responding to failures.

For example, maintenance operations are classified as follows.

(1) Maintenance operations relevant to preventive maintenance, such as periodically replacing various consumable elements by using the number of used sheets and time as references.
(2) Maintenance operations for maintaining the device in a good condition, such as periodically cleaning the inside and outside of the device, making adjustments, and applying a lubricant (not including periodic replacement of elements).
(3) Maintenance operations for recovering failures reported from the user, which can only be recovered by a maintenance person.
(4) Other maintenance operations that do not correspond to any of (1) through (3) described above, such as support provided for assisting the user to use the device.

Conventionally, a system for remotely monitoring a device via a network (hereinafter, “remote management system”) is established for the purpose of enhancing the efficiency of maintenance operations as described above, and providing the user with a device that is constantly in a good condition. According to a remote management system, when an abnormal state or a preliminary state of an abnormality is detected in the device, status information of the device at the time of the detection is automatically transferred to a server. Furthermore, based on a report indicating a preliminary state of an abnormality (abnormality preliminary report) that is automatically transferred, fault prediction is diagnosed. An operator at a call center or a maintenance person performs maintenance operations based on transferred information and diagnosis results.

According to a remote management system, it is possible to reduce the need for a user to report failures. This is because the user is contacted by an operator. Furthermore, a maintenance person, who is sent to a user's site to solve a failure, can be aware of the state of the device in advance, based on information that has been transferred. Therefore, the maintenance person can efficiently and appropriately perform operations to solve failures.

However, there are users who may reject the installation of such a remote management system. Specifically, some users may feel concerned or feel a sense of resistance in terms of security, with regard to the mechanism of automatically transferring information of the device outside the office (i.e., without the user knowing) when an abnormality or a preliminary state of an abnormality is detected. Some users may still be concerned even if the remote management system has a secure communications path provided between the device and an external server.

Patent Document 1: Japanese Patent No. 3290219

Patent Document 2: Japanese Patent No. 3442174

Patent Document 3: Japanese Patent No. 3604504

### SUMMARY OF THE INVENTION

The present invention provides a device management system, a device management apparatus, and a device management method, in which one or more of the above-described disadvantages are eliminated.

A preferred embodiment of the present invention provides a device management system, a device management apparatus, and a device management method capable of mitigating the resistance of users with respect to being monitored from outside.

According to an aspect of the present invention, there is provided a non-transitory computer-readable storage medium with an executable monitor program stored therein, wherein the monitor program instructs a processor of a computer connected to an image forming apparatus via a first network to execute the steps of sending identification information of the monitor program; periodically acquiring status information from the image forming apparatus in response to a request to execute a first process sent by the image forming apparatus that has received the identification information; recording the status information in a storing unit; diagnosing fault prediction of the image forming apparatus based on the status information in response to a request to execute a second process sent by the image forming apparatus from which the status information is acquired; and transferring, to a remote monitor device via a second network, report information including diagnosis results obtained at the diagnosing.

According to an aspect of the present invention, there is provided a device management apparatus connected to an image forming apparatus via a first network, the device management apparatus including a sending unit configured to send identification information of the device management apparatus; a monitor unit configured to periodically acquire status information from the image forming apparatus in response to a request to execute a first process sent by the image forming apparatus that has received the identification information, and record the status information in a storing unit; a diagnosing unit configured to diagnose fault prediction of the image forming apparatus based on the status information in response to a request to execute a second process sent by the image forming apparatus from which the status information is acquired; and a transferring unit configured to transfer, to a remote monitor device via a second network, report information including diagnosis results obtained by the diagnosing unit.

According to an aspect of the present invention, there is provided a device management method executed by a computer connected to an image forming apparatus via a first network, the device management method including sending identification information of the computer; periodically acquiring status information from the image forming apparatus in response to a request to execute a first process sent by the image forming apparatus that has received the identification information; recording the status information in a storing unit; diagnosing fault prediction of the image forming apparatus based on the status information in response to a request to execute a second process sent by the image forming apparatus from which the status information is acquired; and transferring, to a remote monitor device via a second network, report information including diagnosis results obtained at the diagnosing.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a device management system according to an embodiment of the present invention;

FIG. 2 illustrates an example of a functional configuration of the respective devices in a user environment;

FIG. 3 illustrates an example of a hardware configuration of an image forming apparatus according to an embodiment of the present invention;

FIG. 4 illustrates an example of a hardware configuration of a user PC according to an embodiment of the present invention;

FIG. 5 is a sequence diagram for describing a processing procedure for sending widget information of a device monitor widget;

FIG. 6 illustrates an example of widget information of the device monitor widget;

FIG. 7 illustrates an example of a user management table;

FIG. 8 is a sequence diagram for describing a processing procedure for displaying a list of widgets that can be executed;

FIG. 9 indicates a display example of a user selection screen image;

FIG. 10 indicates an example of a configuration of widget information of the device monitor widget sent to the image forming apparatus from a widget management server;

FIG. 11 illustrates a display example of a widget selection screen image;

FIG. 12 is a sequence diagram for describing a processing procedure for executing the device monitor widget;

FIG. 13 illustrates an example how the display state of an icon of the device monitor widget changes; and

FIG. 14 indicates a display example of a report information selection screen image.

### DETAILED DESCRIPTION OF THE PREFERRED EMBODIMENTS

A description is given, with reference to the accompanying drawings, of embodiments of the present invention.

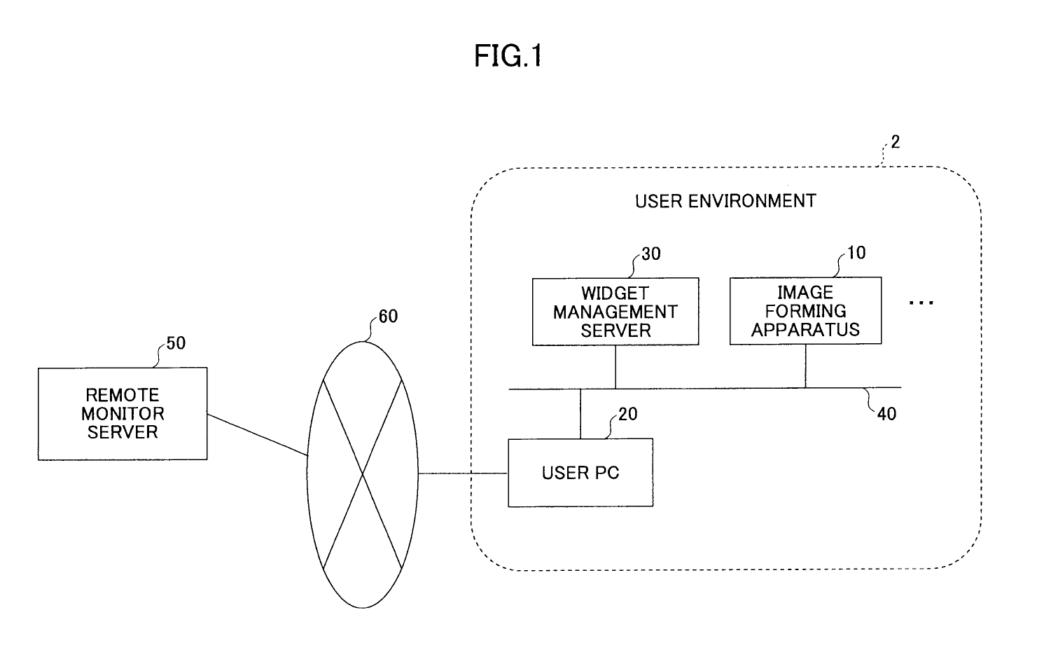

FIG. 1 illustrates an example of a device management system according to an embodiment of the present invention. As shown in FIG. 1, a user environment 2 and a remote monitor server 50 are connected by a wide-area network 60 such as the Internet.

The remote monitor server 50 is located at, for example, the vendor or the manufacturer of an image forming apparatus 10. The remote monitor server 50 is a computer having a function for remotely monitoring the image forming apparatus 10 via the network 60.

The user environment 2 is a computer system provided at, for example, the office of the user of the image forming apparatus 10. As shown in FIG. 1, the user environment 2 includes at least one image forming apparatus 10, a user PC 20, and a widget management server 30, which are connected to a network 40 (wired or wireless) such as LAN (Local Area Network).

The image forming apparatus 10 is a multifunction peripheral for implementing functions such as printing, scanning, copying, and fax transmission, in a single body. However, the image forming apparatus 10 may be a so-called printer that does not have a scanning function. The image forming apparatus 10 is regarded as a monitor target in the present embodiment. The image forming apparatus 10 is hidden from the network 60. Specifically, the image forming apparatus 10 does not perform communications via the network 60. That is to say, it is not possible to access the image forming apparatus 10 from outside the user environment 2.

The user PC 20 is an example of a device management apparatus, among plural PCs (Personal Computers) provided in the user environment 2. The user PC 20 has a function of monitoring the image forming apparatus 10, and sends, to the remote monitor server 50, information relevant to the image forming apparatus 10 that is the monitor target, according to need. The user PC 20 is preferably, for example, a PC used by a user having predetermined authority, such as the administrator of the image forming apparatus 10.

The widget management server 30 mediates communications between the user PC 20 and the image forming apparatuses 10, regarding the execution of a program referred to as a “widget”. Details of a widget are given below.

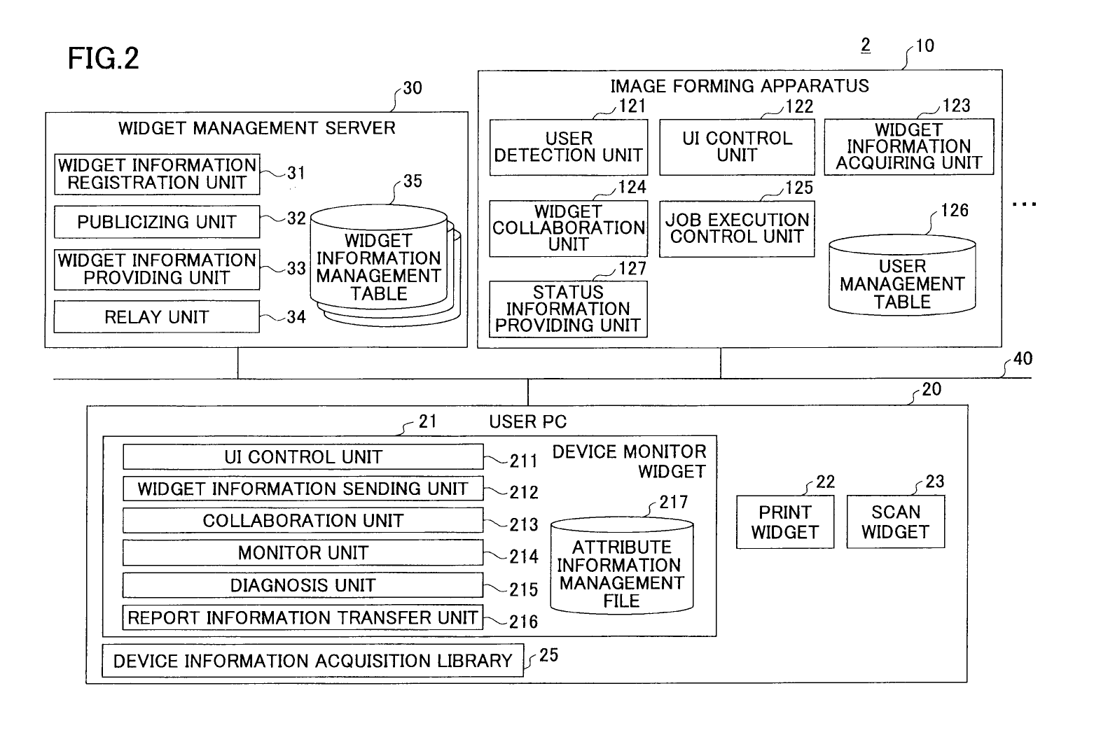

FIG. 2 illustrates an example of a functional configuration of the respective devices in the user environment 2. As shown in FIG. 2, the user PC 20 includes a device monitor widget 21, a print widget 22, a scan widget 23, and a device information acquisition library 25.

The device monitor widget 21, the print widget 22, and the scan widget 23 are application programs that may be collectively referred to as widgets in the present embodiment. The widgets may have different contents. However, all widgets have a common feature of providing a predetermined service by operating in collaboration with the image forming apparatus 10.

The device monitor widget 21 monitors whether an alarm has occurred with respect to the image forming apparatus 10 that is a monitor target, and diagnoses fault prediction for the image forming apparatus 10 corresponding to the alarm. Furthermore, the device monitor widget 21 transfers information indicating diagnosis results (diagnosis result information) to the remote monitor server 50, when approval is given by the user. In this example, an alarm means that a condition that may cause a failure has been detected (a failure has not yet occurred), or a report indicating such a condition.

As shown in FIG. 2, the device monitor widget 21 includes a UI control unit 211, a widget information sending unit 212, a collaboration unit 213, a monitor unit 214, a diagnosis unit 215, a report information transfer unit 216, and an attribute information management file 217.

The UI control unit 211 causes a display device of the user PC 20 to display various display screen images relevant to the device monitor widget 21. The widget information sending unit 212 sends, to the widget management server 30, a request to register widget information of the device monitor widget 21 in accordance with the activation of the device monitor widget 21. The widget information includes identification information of the device monitor widget 21. The identification information of the widget may also correspond to the identification information of the user PC 20. As viewed from the image forming apparatus 10 or the widget management server 30, the procedure of identifying a widget means identifying the user PC 20.

The collaboration unit 213 controls communications (exchange of information) for collaborating with the image forming apparatus 10. The monitor unit 214 periodically refers to the image forming apparatus 10 that is a monitor target, for status information. The status information includes, for example, identification information of the image forming apparatus 10 (device ID), whether an alarm has occurred, values of various counters (e.g., number of printed sheets) in the image forming apparatus 10, a value indicating the accumulated number of times a paper jam has occurred, the number of times an SC (service person call) has been made, ROM information (information of programs recorded in the ROM 113), and image control voltage information. The status information indicating that an alarm has occurred is an example of an abnormality preliminary report.

The diagnosis unit 215 diagnoses fault prediction for the image forming apparatus 10 in which two or more alarms have been detected within a predetermined time period, based on the status information relevant to the alarms. The report information transfer unit 216 transfers, to the remote monitor server 50, diagnosis result information and status information as report information. However, the report information is transferred within the bounds approved by the user. For example, when the user rejects to transfer report information, the report information is not transferred. Even when the user approves to transfer the report information, the report information to be transferred may be limited to only parts of the diagnosis result information and status information.

The attribute information management file 217 is for storing attribute information of the device monitor widget 21. Information that is set or registered in advance in the attribute information includes an identifier (widget ID) of the device monitor widget 21, the user ID of the user who is the owner of the device monitor widget 21, a list of image forming apparatuses 10 to be monitor targets, authentication information for communications of the device monitor widget 21, and information indicating items to be included in the report information.

The print widget 22 is for causing the image forming apparatus 10 with which the user PC 20 can communicate via the network 40, to execute a print job.

The scan widget 23 is for executing a predetermined process (for example, distributing or saving) with respect to image data (scan image) obtained by a scanning operation at the image forming apparatus 10.

The device information acquisition library 25 is a library (for example, DLL (Dynamic Link Library)) provided with API (Application Program Interface) for referring to the image forming apparatus 10 for status information. That is to say, the monitor unit 214 uses the device information acquisition library 25 for referring to the image forming apparatus 10 for status information, and receiving the status information from the image forming apparatus 10. The device information acquisition library 25 is created as a general-purpose library, so that it may be shared by other device management applications (not shown).

Each widget belongs to a user, as can be understood from the fact that the user ID of the owner of the widget is recorded in the attribute information management file 217 of the device monitor widget 21. Therefore, even if two widgets are the same, if they belong to different users, the two widgets are regarded as different widgets. For example, a widget that belongs to a user A can be basically used only by the user A. A widget that belongs to a user B can be basically used only by the user B. However, when another user is given usage authority by an access control function, the other user may be allowed to use a widget that belongs to someone else.

The widget management server 30 is a computer including a widget information registration unit 31, a publicizing unit 32, a widget information providing unit 32, and a relay unit 34. These units are implemented as programs installed in the widget management server 30, and are executed by a CPU of the widget management server 30.

The widget information registration unit 31 receives a request to register widget information sent from the user PC 20, and saves the widget information in a widget information management table 35. The widget information management table 35 is generated in a storage device of the widget management server 30, for each user. That is to say, the widget information management table 35 manages a list of widget information items of widgets belonging to the corresponding user (hereinafter, “widget information list”). The publicizing unit 32 publicizes (broadcasts or multicasts), in the network 40, the user ID included in the widget information received by the widget information registration unit 31. The publication is issued in units of users (in units of user IDs). Specifically, after an publication is issued for user A, even if new widget information belonging to user A is received, a publication corresponding to the new widget information is not made. That is to say, a publication issued by the publicizing unit 32 is information for reporting, to the image forming apparatus 10, that there is a new user who can use one of the widgets. In another example, the publications may be issued in units of widget information items. In this case, plural publications may be redundantly issued for the same user; however, the image forming apparatus 10 may eliminate such redundancy. The widget information providing unit 33 supplies (sends) widget information registered in the widget information management table 35 to the image forming apparatus 10, in response to a request from the image forming apparatus 10. The relay unit 34 relays communications between the widget and the image forming apparatus 10.

The user PC 20 may also act as the widget management server 30. That is to say, programs for implementing the widget information registration unit 31, the publicizing unit 32, the widget information providing unit 33, and the relay unit 34 may be installed in the user PC 20.

The image forming apparatus 10 includes a user detection unit 121, a UI control unit 122, a widget information acquiring unit 123, a widget collaboration unit 124, a job execution control unit 125, a user management table 126, and a status information providing unit 127.

The user detection unit 121 detects the presence of a user who can use a widget based on a publication issued by the widget management server 30, and registers, in the user management table 126, the user ID included in the publication. The user management table 126 is a table for managing a list of users activating widgets in the network 40. The UI control unit 122 receives input of an operation instruction for a widget, from the user. That is to say, a widget is provided in the user PC 20, but the widget may also be operated from the operations panel of the image forming apparatus 10. The widget information acquiring unit 123 acquires, from the widget management server 30, widget information relevant to the user operating the image forming apparatus 10 (i.e., widget information of the widget activated by a user corresponding to the same user ID as the operator). The widget collaboration unit 124 controls communications with a widget. The job execution control unit 125 controls the execution of a job relevant to the function requested by the widget. For example, the job execution control unit 125 controls the execution of a print job or a scan job. The status information providing unit 127 is a server function for the device information acquisition library 25. Specifically, the status information providing unit 127 collects status information from the storage unit in the image forming apparatus 10, in response to a request to acquire status information from the device information acquisition library 25. Then, the status information providing unit 127 returns the collected status information to the device information acquisition library 25. When an alarm has occurred, the status information includes information indicating that an alarm has occurred.

In the image forming apparatus 10 according to the present embodiment, an alarm occurs as a paper jam occurs. For example, the image forming apparatus 10 stores a counter (alarm counter) for determining whether an alarm is to occur. When a paper jam occurs within a predetermined number of sheets set in advance (for example, 1000 sheets), the alarm counter is incremented by one. Meanwhile, if a paper jam does not occur even when the number of sheets exceeds the predetermined number of sheets, the alarm counter is decremented by one, or the alarm counter may be initialized to zero. As a result of operating the alarm counter as described above, when the alarm counter reaches a predetermined threshold (for example, “10”), the alarm mechanism of the image forming apparatus 10 is triggered. In the present embodiment, an example of a specific phenomenon indicating that an alarm has occurred is to record information indicating that an alarm has occurred in a predetermined storage unit. Details of the alarm of the image forming apparatus 10 may be found in, for example, Japanese Patent No. 3442174 and Japanese Patent No. 3604504.

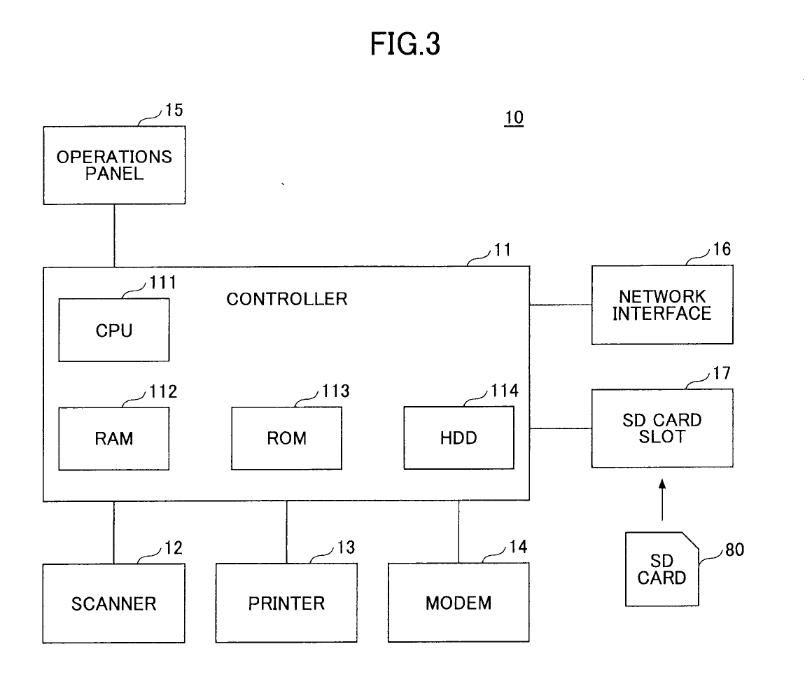

Next, a description is given of hardware configurations of the devices. FIG. 3 illustrates an example of a hardware configuration of the image forming apparatus 10 according to an embodiment of the present invention. As shown in FIG. 3, the image forming apparatus 10 includes hardware elements such as a controller 11, a scanner 12, a printer 13, a modem 14, an operations panel 15, a network interface 16, and an SD card slot 17.

The controller 11 includes a CPU 111, a RAM 112, a ROM 113, and a HDD 114. The ROM 113 records various programs and data used by the programs. The RAM 112 is used as a storage area for loading programs and a work area for the loaded programs. The CPU 111 processes the programs loaded in the RAM 112 to implement various functions. The HDD 114 records programs and various data items used by the programs.

The scanner 12 is a hardware element for scanning an original to obtain image data (image scanning unit). The printer 13 is a hardware element for printing data onto a sheet (printing unit). The modem 14 is a hardware element for connecting the image forming apparatus 10 to a telephone line to transmit and receive image data by fax communications. The operations panel 15 is a hardware element including an input unit such as a pointer for receiving input from a user, and a display unit such as a liquid crystal panel. The network interface 16 is a hardware element for connecting the image forming apparatus 10 to a network (wired or wireless) such as LAN. The SD card slot 17 is used for reading programs recorded in an SD card 80. In the image forming apparatus 10, in addition to programs recorded in the ROM 113, programs recorded in the SD card 80 may also be loaded and executed in the RAM 112.

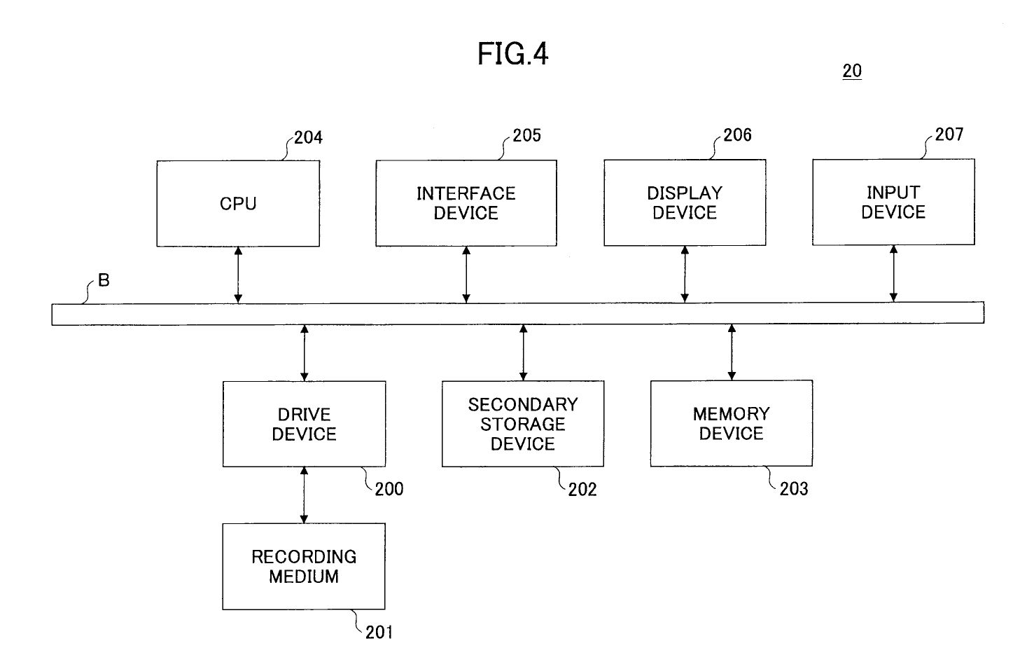

FIG. 4 illustrates an example of a hardware configuration of the user PC 20 according to an embodiment of the present invention. The user PC 20 shown in FIG. 4 includes a drive device 200, a secondary storage device 202, a memory device 203, a CPU 204, an interface device 205, a display device 206, and an input device 207, which are interconnected by a bus B.

Programs for implementing processes at the user PC 20 are provided by a recording medium 201 such as a CD-ROM. When the recording medium 201 recording a program is set in the drive device 200, the program is installed in the secondary storage device 202 via the drive device 200, from the recording medium 201. However, the program need not be installed from the recording medium 201; the program may be downloaded from another computer via a network. The secondary storage device 202 stores the installed program as well as necessary files and data.

The memory device 203 reads a program from the secondary storage device 202 and stores the read program, when an instruction to activate the program is received. The CPU 204 implements functions of the user PC 20 according to the program stored in the memory device 203. The interface device 205 is used for connecting to a network. The display device 206 displays a GUI (Graphical User Interface) according to a program. The input device 207 includes a keyboard and a mouse, and is used for inputting various operation instructions.

In the following, a description is given of a processing procedure of the device management system. First, a description is given of the processing procedure of registering widget information of the device monitor widget 21 in the widget management server 30.

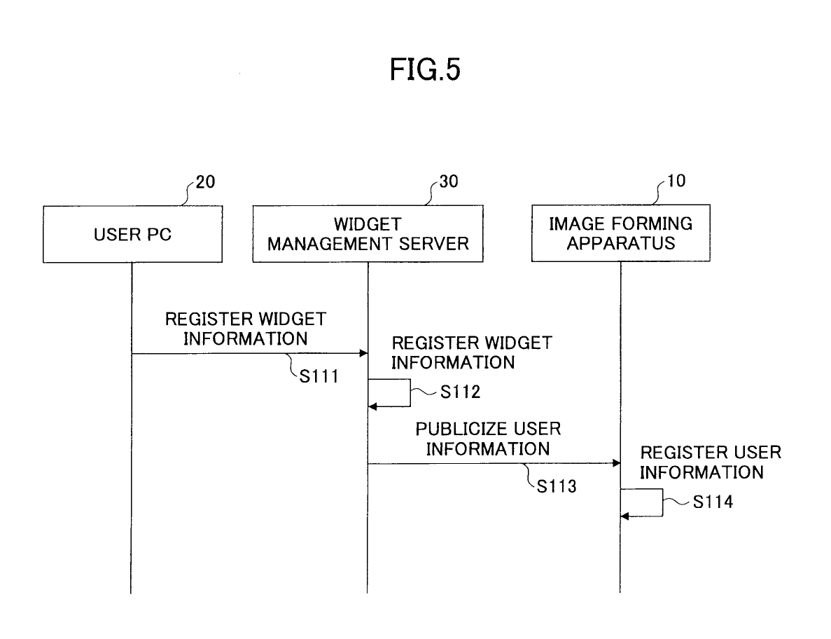

FIG. 5 is a sequence diagram for describing a processing procedure for sending widget information of the device monitor widget 21.

At the user PC 20, when an instruction to activate the device monitor widget 21 is input by a user, the widget information sending unit 212 refers to the attribute information management file 217 and generates widget information, and sends a request to register the widget information to the widget management server 30 (step S111). In each user PC 20, information for communicating with the widget management server 30 is set in advance (for example, an IP address or a host name, etc.).

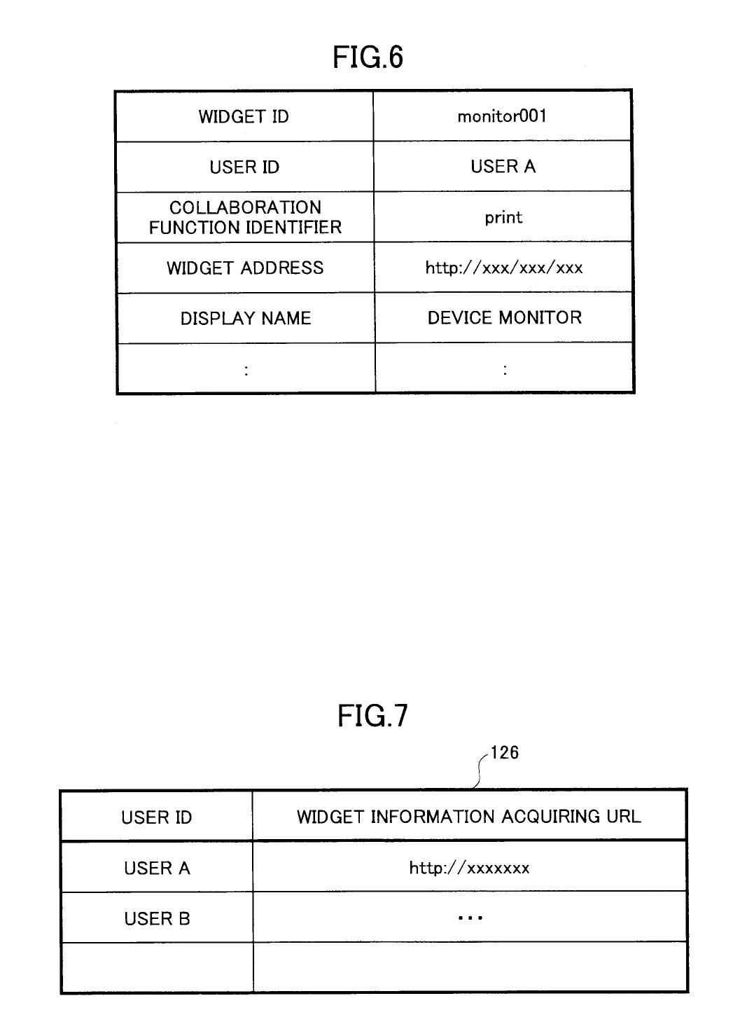

FIG. 6 illustrates an example of widget information of the device monitor widget 21. As shown in FIG. 6, the widget information of the device monitor widget 21 includes a widget ID, a user ID, a collaboration function identifier, a widget address, and a display name.

The widget ID is identification information for uniquely identifying each widget. The user ID is identification information of a user who is the owner of the device monitor widget 21. The collaboration function identifier is information for identifying a function (i.e., a function used by a widget) that the image forming apparatus 10 collaborating with a widget needs to have. Examples of a collaboration function identifier are “print”, “scan”, etc. “Print” indicates a printing function. “Scan” indicates a scanning function. As described below, the device monitor widget 21 uses a printing function of the image forming apparatus 10. Therefore, in the example of FIG. 6, “print” is indicated as the collaboration function identifier. The widget address is identification information (for example, a URL) for uniquely identifying each widget in network communications. The display name is a character string for displaying the name of the widget. The widget ID, the user ID, the collaboration function identifier, the widget address, and the display name are acquired from, for example, the attribute information management file 217.

In step S111, the widget information sent by the widget information sending unit 212 is received by the widget information registration unit 31 of the widget management server 30. The widget information registration unit 31 registers the widget information in the widget information management table 35 corresponding to the user ID included in the received widget information. When there is no widget information management table 35 that corresponds to the user ID, the widget information registration unit 31 generates a widget information management table 35 corresponding to the user ID, and registers the widget information in the generated widget information management table 35 (step S112).

When a new widget information management table 35 is generated (i.e., when widget information of the user relevant to the user ID included in the received widget information, is registered for the first time), the publicizing unit 32 issues, in the network 40, a publication including the user ID included in the received widget information and a URL (Uniform Resource Locator) for acquiring the widget information (widget information acquiring URL) (step S113). The widget information acquiring URL is a URL that is unique to each widget information management table 35. For example, when the widget information registration unit 31 generates the widget information management table 35, the widget information registration unit 31 also generates a widget information acquiring URL for the widget information management table 35. The widget information management table 35 is generated for each user. Therefore, the widget information acquiring URL is unique to each user.

Next, when the publication is received, the user detection unit 121 of the image forming apparatus 10 registers, in the user management table 126, the user ID and widget information acquiring URL included in the publication (step S114).

FIG. 7 illustrates an example of the user management table 126. As shown in FIG. 7, the user management table 126 is for managing pairs of user IDs and widget information acquiring URLs. FIG. 7 indicates an example where records are registered for user A and user B. The user management table 126 is, for example, stored in the HDD 114.

After executing the process of FIG. 5, the user moves to the location where the image forming apparatus 10 is installed, for executing the device monitor widget 21. When there are plural image forming apparatuses 10 connected to the network 40, the same publication is received by the user detection units 121 of the respective image forming apparatuses 10, and the user ID and widget information acquiring URL is registered in the user management tables 126 of the respective image forming apparatuses 10. Therefore, the user can execute a job relevant to each widget by operating any one of the plural image forming apparatuses 10. The same processing procedure as that of FIG. 5 is executed when the print widget 22 or the scan widget 23 is activated. Consequently, the widget information of the print widget 22 or the scan widget 23 is registered in the widget information management table 35 of the widget management server 30.

Next, a description is given of a process executed in accordance with operations by the user at the image forming apparatus 10.

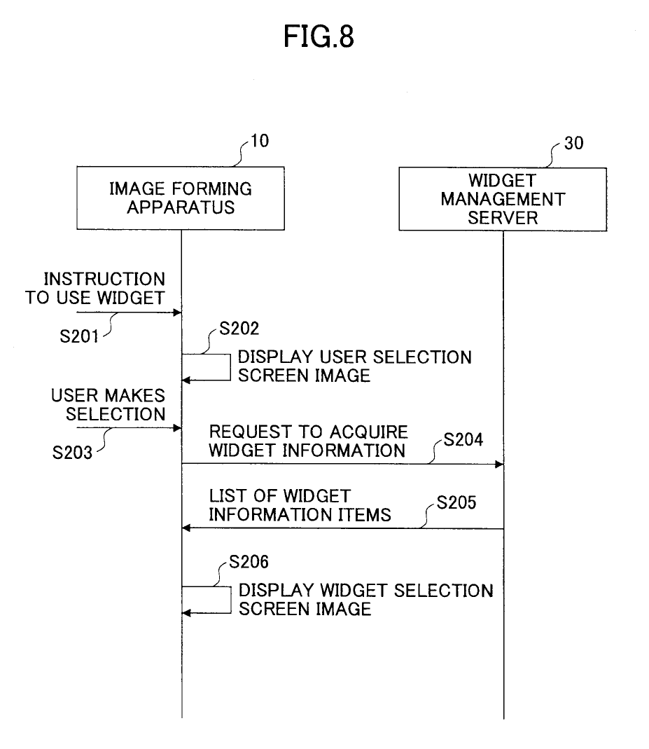

FIG. 8 is a sequence diagram for describing a processing procedure for displaying a list of widgets that can be executed.

When a user inputs an instruction to use a widget via the operations panel 15 (step S201), the UI control unit 122 of the image forming apparatus 10 causes the operations panel 15 to display a user selection screen image based on information registered in the user management table 126 (step S202).

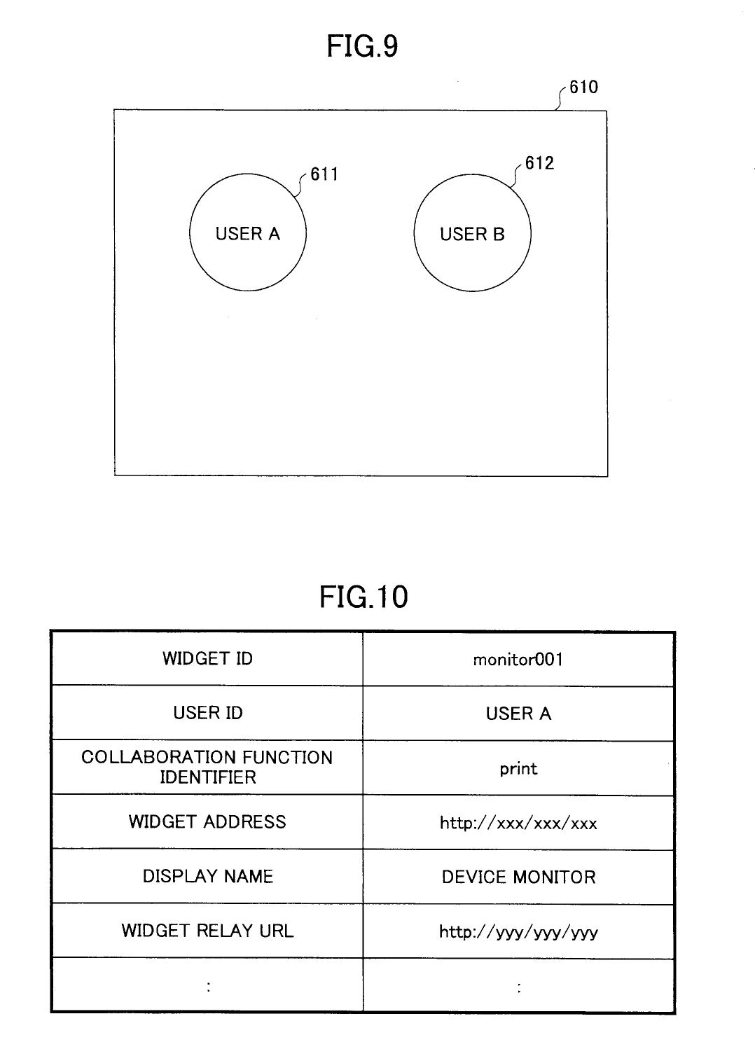

FIG. 9 indicates a display example of a user selection screen image 610. In the user selection screen image 610 shown in FIG. 9, buttons are displayed for respective users. In FIG. 9, a button 611 corresponding to a user A and a button 612 corresponding to a user B are displayed.

Next, the user presses a button corresponding to his own user ID in the user selection screen image 610 (step S203). When the button is pressed, the widget information acquiring unit 123 acquires, from the user management table 126, a widget information acquiring URL associated with the user ID corresponding to the select button. In another example, user authentication may be performed as the button corresponding to the user ID is pressed, and subsequent processes may be performed only when the user authentication is successful.

Next, the widget information acquiring unit 123 sends a request to acquire widget information to the acquired widget information acquiring URL (step S204). The request to acquire widget information is received by the widget information providing unit 33 of the widget management server 30. The widget information providing unit 33 acquires all widget information items registered in the widget information management table 35 corresponding to the widget information acquiring URL (i.e., the widget information management table 35 corresponding to the user operating the image forming apparatus 10), and returns a list of the acquired widget information items to the image forming apparatus 10 (step S205). When returning the list of the acquired widget information items, the widget information providing unit 33 uniquely generates a URL for relaying communications between the image forming apparatus 10 and the respective widgets (hereinafter, “widget relay URL”), for each widget (for each widget information item). The widget information providing unit 33 adds the widget relay URLs generated for the widgets to the widget information items, and sends, to the image forming apparatus 10, the list of widget information items in which widget relay URLs have been added. Thus, the widget information sent in step S205 may have a configuration as indicated in FIG. 10, for example.

FIG. 10 indicates an example of a configuration of widget information of the device monitor widget 21 sent to the image forming apparatus 10 from the widget management server 30.

The widget information shown in FIG. 10 is formed by adding a widget relay URL to the widget information shown in FIG. 6. That is to say, a widget information list as shown in FIG. 10 is sent in step S205. A widget information list may only include one widget information item.

Next, the UI control unit 122 of the image forming apparatus 10 records the received widget information list in the RAM 112, and displays a screen image (widget selection screen image) including a list of widgets that can be executed, based on the widget information list (step S206).

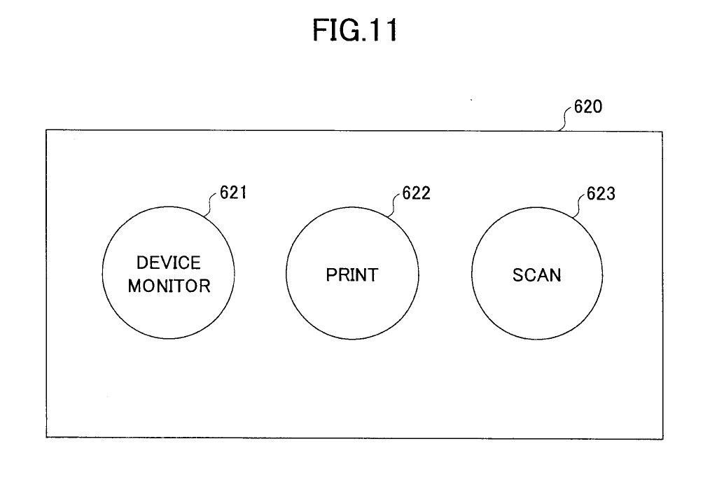

FIG. 11 illustrates a display example of a widget selection screen image 620. The widget selection screen image 620 displays buttons (display elements) for the respective widgets. In FIG. 11, a button 621 corresponding to the device monitor widget 21, a button 622 corresponding to the print widget 22, and a button 623 corresponding to the scan widget 23 are displayed.

The processing procedure after displaying the widget selection screen image 620 differs according to the type of the selected widget to be executed. In the present embodiment, a description is given of a processing procedure performed when the device monitor widget 21 is selected as the execution target.

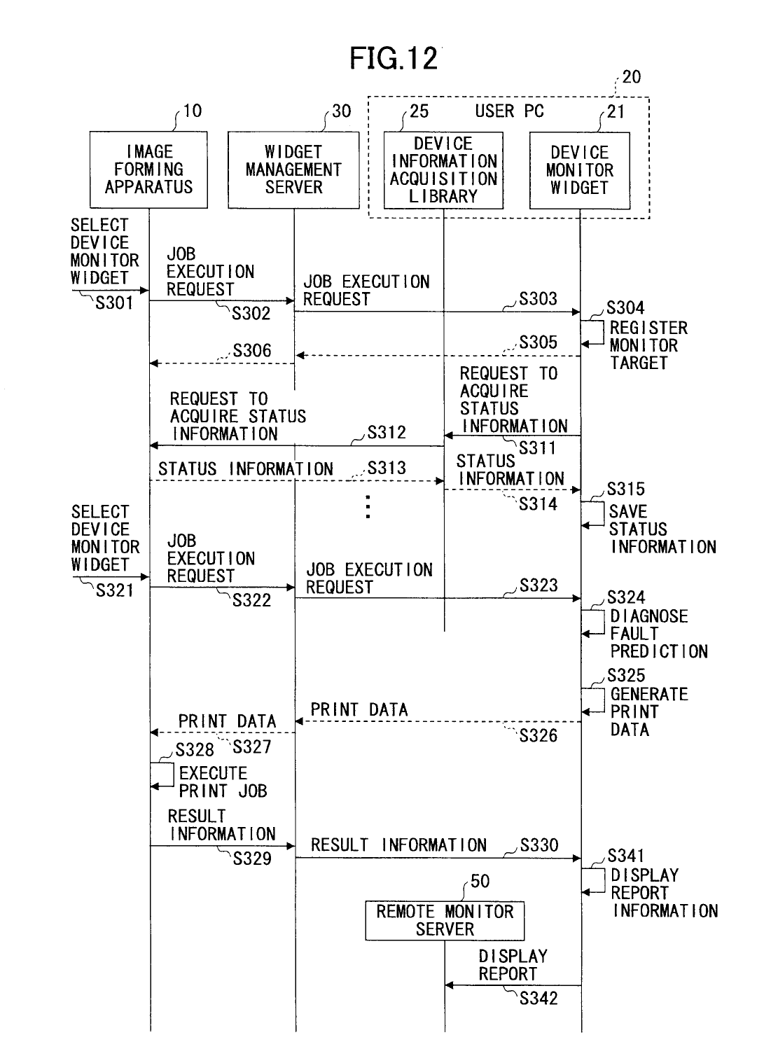

FIG. 12 is a sequence diagram for describing a processing procedure for executing the device monitor widget 21.

When the button 621 corresponding to the device monitor widget 21 is displayed in the widget selection screen image 620, and the corresponding image forming apparatus 10 is to be the monitor target, the user presses (selects) the button 621 and presses the start key (step S301). When the button 621 and the start key are pressed, the widget collaboration unit 124 recognizes that printing is to be executed based on the collaboration function identified (“print”) included in the widget information (hereinafter, “current widget information”) corresponding to the pressed button 621. In order to execute printing, it is necessary to obtain print data. Thus, the widget collaboration unit 124 sends a request to execute a job (a request to execute a process) to the widget relay URL included in the current widget information (step S302). The widget collaboration unit 124 expects to receive print data generated as a result of executing the job of the device monitor widget 21. The request to execute a job (job execution request) includes identification (for example, an IP address) used for communications of the image forming apparatus 10.

The job execution request sent to the widget relay URL is received by the relay unit 34 of the widget management server 30. The relay unit 34 acquires, from the widget information management table 35, widget information corresponding to the widget relay URL, and transfers a job execution request to the widget address included in the widget information (step S303).

The job execution request sent to the widget address is received by the collaboration unit 213 of the device monitor widget 21 in the user PC 20. The collaboration unit 213 determines whether the IP address in the job execution request is included in a monitor target list. The monitor target list (storage unit) is a list in the secondary storage device 202 for storing the IP addresses of image forming apparatuses 10 that are monitor targets (targets from which status information is acquired) of the monitor unit 214. When the IP address included in the job execution request is recorded in the monitor target list, step S325 and onward are executed. Meanwhile, when the IP address included in the job execution request is not recorded in the monitor target list, the collaboration unit 213 registers the IP address in the monitor target list (step S304).

That is to say, the collaboration unit 213 of the device monitor widget 21 interprets the job execution request received in step S303 as a request to register the image forming apparatus 10 to be the monitor target. Specifically, the collaboration unit 213 returns, to the relay unit 34 of the widget management server 30, a dummy response instead of print data (step S305). The relay unit 34 transfers the dummy response to the widget collaboration unit 124 of the image forming apparatus 10 (step S306). A dummy response is a dummy message, in which the part where print data is supposed to be stored is empty. When the dummy response is received, the widget collaboration unit 124 ends the process performed in response to the button 621 being pressed, without executing a print job.

As seen in the above processing procedure, the device monitor widget 21 does not automatically search for an image forming apparatus 10 connected to the network 40, and automatically register the search-found image forming apparatus 10 as a monitor target. Instead, the device monitor widget 21 registers, as the monitor target, the image forming apparatus 10 at which the button 621 (see FIG. 11) corresponding to the device monitor widget 21 has been selected. That is to say, the user needs to select the button 621 corresponding to the device monitor widget 21 by operating the image forming apparatus 10 that the user intends to select as a monitor target.

As the button 621 corresponding to the device monitor widget 21 needs to be selected, the user can confirm the actual image forming apparatus 10 and determine whether to select the image forming apparatus 10 as a monitor target. Thus, compared to a case where a monitor target is automatically registered, more importance is placed on the user's intention as to which image forming apparatus 10 is to be selected the monitor target. Furthermore, the user himself can perform the operation of selecting the image forming apparatus 10 to be the monitor target via the operations panel 15, and therefore the user can clearly recognize the location of the image forming apparatus 10 that is the monitor target, in addition to merely confirming the identification information such as the name of the image forming apparatus 10 that is the monitor target.

From the time point when the monitor target is registered (i.e., from the time point when the first IP address is registered in the monitor target list), the monitor unit 214 of the device monitor widget 21 starts monitoring the monitor target. Specifically, the monitor unit 214 specifies the IP address registered in the monitor target list as a parameter, and calls a status information acquiring function of the device information acquisition library 25 (step S311). The status information acquiring function sends a request to acquire status information (refer whether an alarm has occurred), to the status information providing unit 127 of the image forming apparatus 10 corresponding of the specified IP address (for example, to a port number corresponding to the status information providing unit 127) (step S312).

The status information providing unit 127 that has received the acquisition request collects status information from various storage units of the image forming apparatus 10. The status information may include a device ID, an indication whether an alarm has occurred, various counter values, a value indicating the accumulated number of times that a paper jam has occurred, the number of times an SC (serviceman call) has been made, ROM information, and image control voltage information. The indication whether an alarm has occurred is acquired by confirming whether a predetermined storage unit (for example, a predetermined file in the HDD 114) records information indicating that an alarm has occurred. The status information providing unit 127 returns the collected status information (step S313). An identifier may be assigned to each alarm (alarm ID) so that it can be identified whether the alarms are the same. In this case, the alarm ID is also included in the status information. Once an alarm occurs, the state of the alarm continues. Therefore, there may be a case where status information indicating the same alarm (that has occurred once) is returned plural times, in response to requests to acquire status information that are repeatedly given. In such a case, as described below, the device monitor widget 21 changes the control process in accordance to the number of times an alarm has occurred, and therefore it is necessary that the actual number of times an alarm has occurred can be determined. In another example, if an alarm has already been reported once by returning status information, the status information providing unit 127 may be set not to report the alarm again. In this example, when returning status information indicating that the alarm has occurred, the status information providing unit 127 deletes the information indicating that the alarm has occurred from a predetermined storage unit.

The status information acquiring function of the device information acquisition library 25 outputs the received status information to the monitor unit 214 of the device monitor widget 21 (step S314). When the status information indicates that an alarm has occurred, the monitor unit 214 records (saves) the status information in the secondary storage device 202, in association with the IP address of the image forming apparatus 10 (step S315). Furthermore, the monitor unit 214 adds one to the value indicating the number of times an alarm has occurred (hereinafter, “alarm frequency counter”), which is stored in the secondary storage device 202 for each IP address of the image forming apparatus 10.

The monitor unit 214 periodically and repeatedly acquires the status information. When plural IP addresses are registered in the monitor target list, the respective image forming apparatuses 10 return status information, in a serial or parallel manner. Accordingly, the status information items indicating alarms are recorded in the secondary storage device 202, in a manner such that the status information items are associated with the respective IP addresses (i.e., the status information items are distinguished in terms of the image forming apparatus 10).

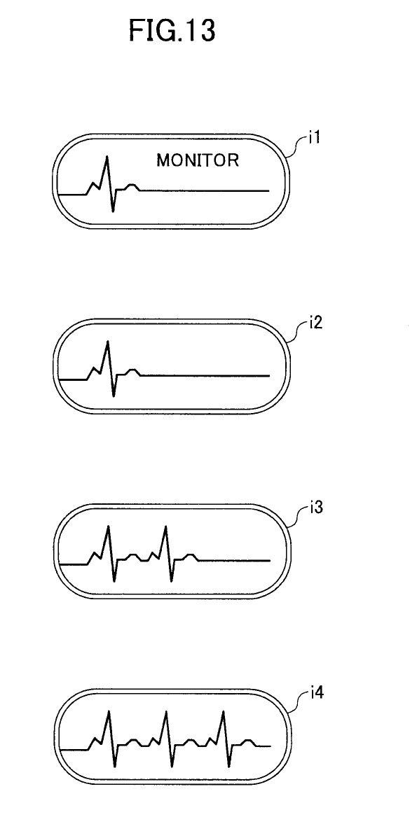

Incidentally, the UI control unit 211 of the device monitor widget 21 causes the display device 206 to display an image (icon) indicating that the device monitor widget 21 is activated after the device monitor widget 21 has been activated. The UI control unit 211 changes the display status of the icon, for example as illustrated in FIG. 13, in accordance with the status of the device monitor widget 21 or the status of the image forming apparatus 10 that is the monitor target (in accordance with whether an alarm has occurred in the image forming apparatus 10 that is the monitor target).

FIG. 13 illustrates an example how the display state of an icon of the device monitor widget 21 changes. In FIG. 13, an icon i1 indicates that there are no monitor targets. Specifically, when there are no IP addresses registered in the monitor target list, the UI control unit 211 displays the icon i1. An icon i2 indicates that the status of the image forming apparatus 10 is good (regular/normal). Specifically, when the received status information indicates a status that an alarm has not occurred (regular status), the widget information sending unit 212 displays the icon i2. An icon i3 indicates that the image forming apparatus 10 is in a status that an alarm has occurred. Specifically, when a response to a request to acquire status information indicates that an alarm has occurred, the widget information sending unit 212 displays the icon i3. An icon i4 indicates than an alarm has occurred two times or more. Specifically, the widget information sending unit 212 can recognize (determine) the number of times an alarm has occurred with the alarm frequency counter. When an alarm has occurred two times or more, i.e., when the alarm frequency counter indicates two or more, the widget information sending unit 212 displays the icon i4.

In the icons, waveforms are shown. The waveforms express the extent to which the status of the image forming apparatus 10 has changed from the regular status. The period of waveforms is reduced as the icon number increases from icon i2 to icon i3. Accordingly, by confirming the shape of the waveforms shown in the icon, the user can immediately recognize the status of the image forming apparatus 10. The color of the waveforms may be changed, in addition to changing the period of the waveforms. For example, the color of the waveforms of the in icon i1 and the icon i2 may be blue or green, the color of the waveforms in the icon i3 may be yellow, and the color of the waveforms in the icon i4 may be red. Accordingly, the user can recognize the extent to which the status of the image forming apparatus 10 has changed, even more intuitively.

One icon may be displayed for each image forming apparatus 10 that is a monitor target, or one icon may be displayed for plural monitor targets. In the latter case, when any one of the image forming apparatuses 10 corresponds to the status of the icon i3 or the icon i4, the corresponding icon is to be displayed.

As described above, with the use of an icon of the device monitor widget 21 displayed on the display device 206 of the user PC 20, the user can confirm how the status of the image forming apparatus 10 has changed. For example, if the icon i4 is displayed, the user moves to the location of the image forming apparatus 10 in an alarm status, and performs the operation described with reference to FIG. 8. Accordingly, the widget selection screen image 620 is displayed at the image forming apparatus 10.

When the user approves or desires to diagnose fault prediction (fault prediction diagnosis) regarding the image forming apparatus 10, and to transfer the diagnosis result information to the remote monitor server 50, the user presses (selects) the button 621 corresponding to the device monitor widget 21 in the widget selection screen image 620, and presses the start key of the operations panel 15 (step S321 of FIG. 12). Specifically, to select the button 621 relevant to an image forming apparatus 10 that is not a monitor target means that the user has indicated his intention of selecting the corresponding image forming apparatus 10 as a monitor target. Meanwhile, to select the button 621 relevant to an image forming apparatus 10 that is already a monitor target means that the user has indicated his intention of allowing fault prediction diagnosis regarding the image forming apparatus 10 and to transfer outside the diagnosis result information (report information).

Next, the process contents of steps S322 and S323 are the same as the process contents of steps S302 and S303. Specifically, the job execution request is received by the collaboration unit 213 of the device monitor widget 21 in the user PC 20. The collaboration unit 213 determines whether the IP address in the job execution request is included in the monitor target list. In this example, the IP address corresponds to the image forming apparatus 10 that is already selected as a monitor target, and the IP address is thus included in the monitor target list. The collaboration unit 213 confirms the alarm frequency counter corresponding to the IP address. When the alarm frequency counter indicates two or more, the collaboration unit 213 determines that the job execution request is a request to execute fault prediction diagnosis regarding the image forming apparatus 10 relevant to the IP address and to transfer outside the diagnosis result information.

In response to the determination by the collaboration unit 213, the diagnosis unit 215 executes the process of fault prediction diagnosis with the use of status information items recorded when the last two alarms occurred, which are recorded in association with the IP address (step S324). That is to say, it is diagnosed whether there is a possibility of a fault. The process of diagnosing fault prediction may be performed based on the methods described in Japanese Laid-Open Patent Publication No. 2000-253199 and Japanese Laid-Open Patent Publication No. 2000-270141. However, a method according to any other known technology may be applied to diagnose fault prediction. When another known technology is applied, the status information is to include information required by the corresponding known technology. That is to say, as long as the status information includes information required for diagnosing fault prediction, any method is applicable to the present embodiment. The diagnosis unit 215 records diagnosis result information in the memory device 203 or the secondary storage device 202, as an execution result of the process of diagnosing fault prediction.

Next, the report information transfer unit 216 uses a printer driver installed in the user PC 20, and generates print data (PDL (Page Description Language)) for printing report information including the diagnosis result information and status information to be transferred to the remote monitor server 50 together with the diagnosis result information (step S325). However, when the image forming apparatus 10 can receive data in a general-purpose data format as the print data (examples of data in a general-purpose data format are TIFF (Tagged Image File Format) data and PDF (Portable Document Format) data), the report information may be converted to data in the corresponding data format, and the converted data may be used as print data.

Next, the collaboration unit 213 returns the generated print data to the relay unit 34 of the widget management server 30, as a response to the job execution request received at step S323 (step S326). The print data corresponds to a print request of the report information. The relay unit 34 transfers the print data to the widget collaboration unit 124 of the image forming apparatus 10 (step S327).

The widget collaboration unit 124 of the image forming apparatus 10 inputs the received print data to the job execution control unit 125. Next, the job execution control unit 125 executes a print job relevant to the received print data (step S328). As a result, a sheet on which the report information is printed is output from the printer 13. From the viewpoint of the user, it appears as if a sheet on which the report information is printed is immediately output when the user selects the button 621 and presses the start key in the widget selection screen image 620. The user can confirm the contents of the information that is about to be transferred to the remote monitor server 50, by looking at the sheet.

When the print job is completed, the widget collaboration unit 124 sends print job result information (information indicating whether the job is successful) to the widget relay URL included in the widget information of the device monitor widget 21 that is the execution target (step S329). The result information sent to the widget relay URL is received by the relay unit 34 of the widget management server 30. The relay unit 34 acquires widget information corresponding to the widget relay URL from the widget information management table 35, and transfers the result information of a widget address included in the acquired widget information (step S330).

The result information sent to the widget address is received by the collaboration unit 213 of the device monitor widget 21 in the user PC 20. The collaboration unit 213 inputs the result information in the report information transfer unit 216. The report information transfer unit 216 causes the display device 206 to display a report information selection screen image used for selecting information to be included in the report information from the status information, when the result information is indicating that printing is successful (step S341). However, the report information selection screen image may be executed according to a predetermined operation on the icon of the device monitor widget 21 (for example, selecting a menu item in a context menu displayed by right-clicking the icon).

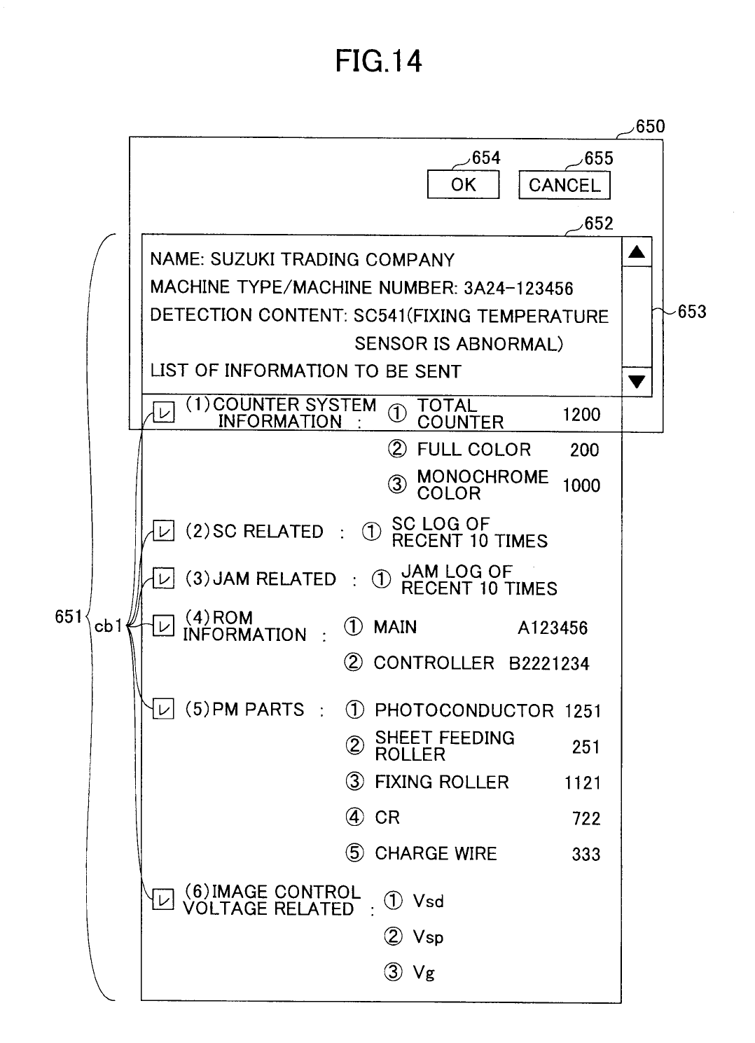

FIG. 14 indicates a display example of a report information selection screen image 650. As shown in FIG. 14, the report information selection screen image 650 includes a status information display area 651, a window 652, a scroll bar 653, an OK button 654, and a cancel button 655.

In the status information display area 651, contents of the status information received from the image forming apparatus 10 are displayed in terms of separate items, and check buttons ch1 are provided for the respective items. Items with ticked check buttons ch1 (selected items) are included in the report information. Items with unticked check buttons ch1 (items not selected) are not included in the report information. As described above, with the report information selection screen image 650, contents of the report information can be edited. Thus, the user can limit or restrict the information to be sent outside as report information, according to his own intention. When there is a hierarchy to the items (when there are plural items under each item), the lower-level items may also have check buttons. For example, the item “(4) ROM information” includes lower-level items of “(1) main” and “(2) controller”. In this case, check buttons may be provided for “(1) main” and “(2) controller”. The actual status information includes 1000 or more items. In FIG. 14, only some of the items in the status information are displayed as a matter of convenience. The status information includes a large amount of information as described above, and therefore it is a burden to tick the check buttons ch1 every time the report information is sent. Therefore, the report information transfer unit 216 may save the selected state of the check buttons cb1, i.e., information indicating whether each item of the status information is to be included in the report information, in the attribute information management file 217. The next time the status information display area 651 is to be displayed, the report information transfer unit 216 sets the state of the check buttons cb1 based on the information saved in the attribute information management file 217. Alternatively, information indicating whether each item of the status information is to be included in the report information may be set in the attribute information management file 217 in advance. In this case, for example, the UI control unit 211 can display a setting screen image in which check buttons are provided for the respective items in the status information, and save, in the attribute information management file 217, the contents set in the setting screen image.

The window 652 displays the part (area) set as a display target in the status information display area 651. The scroll bar 653 is a component used for selecting the part to be the display target in the status information display area 651. The cancel button 655 is for receiving an instruction to cancel the operation of transferring the report information. That is to say, when the cancel button 655 is pressed, the report information transfer unit 216 does not transfer the report information.

The OK button 654 is for receiving an instruction to send the report information. That is to say, when the OK button 654 is pressed, the report information transfer unit 216 extracts information relevant to an item with a selected check button cb1 from the status information, and sends report information including the extracted information and the diagnosis result information to the remote monitor server 50 (step S342). The report information may be sent by using a communications protocol unique to the remote monitor server 50, or a general-purpose communications protocol such as e-mail or FTP (File Transfer Protocol).

The remote monitor server 50 analyzes the received report information, and automatically executes a process according to contents of the report information. For example, the remote monitor server 50 transfers the report information to a computer of the call center. At the call center, the operator makes a telephone call to the user based on the report information, and confirms the status. When the operator determines that a maintenance person needs to be dispatched based on the telephone call, a maintenance person is dispatched. Therefore, the report information may be regarded as information for requesting maintenance operations for the image forming apparatus 10.

As described above, according to the present invention, when an alarm occurs in the image forming apparatus 10 that is a monitor target, the report information is sent to the remote monitor server 50 only when the user has explicitly indicated an indication to do so. That is to say, the report information is sent to the remote monitor server 50 when the user selects the button 621 corresponding to the device monitor widget 21 at the image forming apparatus 10. Therefore, it is possible to prevent the report information from being transferred without the user knowing. Furthermore, the user can limit the items to be transferred, at the report information selection screen image 650 displayed in the device monitor widget 21. Consequently, it is possible to mitigate concern or resistance with respect to transferring outside the information relevant to the image forming apparatus 10 without the user knowing.

Furthermore, in the present embodiment, communications with the remote monitor server 50 are performed with the user PC 20. Therefore, the image forming apparatus 10 may be hidden from a wide-area network. Furthermore, the report information can be sent by a communications protocol such as e-mail, which is convenient to the user environment 2. The user can feel safe in this respect also.

In FIG. 12, the operations of printing the report information in step S328 and the operation of displaying the report information selection screen image 650 in step S341 may be omitted. This is because it can be considered that the user has given permission to send the report information when the user presses the button 621 in step S321. That is to say, the operation of pressing the button 621 allows the user to have the opportunity of determining whether to send the report information. In this case, by pressing the button 621 and the start key, the steps up to the operation of sending the report information (step S342) are automatically executed.

It can be set in the attribute information management file 217 of the device monitor widget 21, as to whether to print the report information or whether to display the report information selection screen image 650. Specifically, when it is set in the attribute information management file 217 not to print the report information, the report information transfer unit 216 returns a dummy response in step S326, similar to step S305. Consequently, print data of the report information is not transferred to the image forming apparatus 10, and the report information is prevented from being printed. Furthermore, when it is set in the attribute information management file 217 not to display the report information selection screen image 650, the report information transfer unit 216 transfers the report information (step S342) without displaying the report information selection screen image 650. However, in this case also, when items to be included in the report information are specified in the attribute information management file 217, only the information relevant to the specified items is sent as report information, instead of sending the entire status information.

Furthermore, in the present embodiment, operations with respect to the user PC 20 and the image forming apparatus 10 (operations described with respect to FIGS. 5, 8, 12, etc.) may be performed by a maintenance person of the image forming apparatus 10.

According to an embodiment of the present invention, a device management system is provided, capable of mitigating resistance of users with respect to being monitored from outside.

The present invention is not limited to the specific embodiments described herein, and variations and modifications may be made without departing from the scope of the present invention.

The present application is based on Japanese Priority Patent Application No. 2010-161884, filed on Jul. 16, 2010, the entire contents of which are hereby incorporated herein by reference.

What is claimed is:

1. A non-transitory computer-readable storage medium with an executable monitor program stored therein, wherein the monitor program instructs a processor of a computer connected to an image forming apparatus via a first network to execute the steps of:
sending identification information of the monitor program;
periodically acquiring status information from the image forming apparatus in response to a request to execute a first process sent by the image forming apparatus that has received the identification information;
recording the status information in a storing unit;
diagnosing fault prediction of the image forming apparatus based on the status information in response to a request to execute a second process sent by the image forming apparatus from which the status information is acquired; and
transferring, to a remote monitor device via a second network, report information including diagnosis results obtained at the diagnosing.

2. The non-transitory computer-readable storage medium according to claim 1, further comprising the steps of:
sending, to the image forming apparatus, a print request to print the report information; and
receiving confirmation that the image forming apparatus printed the report information in response to the print request.

3. The non-transitory computer-readable storage medium according to claim 1, further comprising the steps of:
displaying a screen image indicating the report information on the display device; and
sending the report information to the remote monitor device in response to an instruction to send the report information being entered into the screen image.

4. The non-transitory computer-readable storage medium according to claim 3, wherein
the transferring step further includes sending, to the report monitor device, a part of the report information selected as a sending target in the screen image.

5. The non-transitory computer-readable storage medium according to claim 1, further comprising the step of:
displaying an image corresponding to a status indicated by the status information.

6. A device management apparatus connected to an image forming apparatus via a first network, the device management apparatus comprising:
a sending unit configured to send identification information of the device management apparatus;
a monitor unit configured to periodically acquire status information from the image forming apparatus in response to a request to execute a first process sent by the image forming apparatus that has received the identification information, and record the status information in a storing unit;
a diagnosing unit configured to diagnose fault prediction of the image forming apparatus based on the status information in response to a request to execute a second process sent by the image forming apparatus from which the status information is acquired; and
a transferring unit configured to transfer, to a remote monitor device via a second network, report information including diagnosis results obtained by the diagnosing unit.

7. A device management method executed by a computer connected to an image forming apparatus via a first network, the device management method comprising:
sending identification information of the computer;
periodically acquiring status information from the image forming apparatus in response to a request to execute a first process sent by the image forming apparatus that has received the identification information;
recording the status information in a storing unit;
diagnosing fault prediction of the image forming apparatus based on the status information in response to a request to execute a second process sent by the image forming apparatus from which the status information is acquired; and
transferring, to a remote monitor device via a second network, report information including diagnosis results obtained at the diagnosing.

8. A device management system according to claim 6, wherein
the image forming apparatus includes
a display control unit configured to display, on a display device, a display element corresponding to the received identification information, and
a communications control unit configured to send, to the device management apparatus, the request to execute the first process or the request to execute the second process, in response to the display element being selected.
